(19) United States
(12) Patent Application Publication
(10) Pub. No.: US 2008/0226907 A1
(43) Pub. Date: Sep. 18, 2008

(54) Label Comprising a Liquid-Sensitive Adhesive Coating, Use of Such a Label, Method for Automatically Applying a Label Comprising a Liquid-Sensitive Adhesive Coating, and Method for the Production of a Label Paper

(76) Inventor: Willi Suhner, Gunzwil (CH)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/883,655

(22) PCT Filed: Jan. 24, 2006
(86) PCT No.: PCT/EP06/00572

§ 371 Date: Apr. 4, 2008

(30) Foreign Application Priority Data
Feb. 9, 2005 (EP) 05002687.1

(51) Int. Cl. B32B 33/00; B32B 38/14

(52) U.S. Cl. 428/355 CP; 156/277

(57) ABSTRACT

The invention relates to a label comprising a liquid-sensitive adhesive coating on the rear face thereof. The adhesive coating is based on natural biopolymers and the derivatives thereof and/or synthetic polymers that can be activated by means of liquid. Also disclosed are the use of such a label, a method for automatically applying a label to a receptacle, and a method for producing a label paper.

### BACKGROUND OF THE INVENTION

The invention relates to a label including a liquid-sensitive adhesive coating, the use of such a label, a process for the automatic application of a label including a liquid-sensitive adhesive coating as well as to a process for the manufacture of a label paper.

When furnishing containers, in particular bottles, with labels, the wet labelling method is still the most cost-effective application method. This is due, on the one hand, to the materials used for the labels and adhesive and, on the other hand, machine technology is available for maximum possible efficiencies up to extreme output capacity. Thus, in practice, such equipment attains an output of 60,000 labels per hour.

In the publication “Handbuch der Etikettiertechnik—Grundlagen und Praxis erfolgreicher Produktausstattung” [“Manual of labelling technology—bases and practice of successful product application”], published by Volker Kronseder, 6th edition 2001, pages 173 to 189, wet label technology and related applications are described under “5.1 Erfahrener Leistungstrager—Die Nassetikettierung” [“5.1 Experienced efficiency enhancers—Wet Labelling”].

As a rule, in wet label applications, paper labels are employed which are not pre-coated with adhesive on the rear side. Instead, for fixing the labels to the containers, a water-based adhesive is used. These types of adhesive are normally processed at relatively low temperatures, which is also referred to as cold-adhesive technology in this context.

Depending on the principles employed, a distinction is made in wet labelling technology, as described above, between machinery sets having stationary label magazines and oscillating palettes, on the one hand, and pivotal label magazines on the other hand. In the case of machinery sets having stationary label containers and oscillating palettes the adhesive is applied onto an adhesive roller, which is passed by a palette carrousel carrying a plurality of palettes. The palettes are coated with adhesive. Each respective palette rolls against the rear surface of the paper label about to be issued by the palette magazine and withdraws the label paper from the magazine. The label adhering to the particular palette is passed on to a gripping cylinder, which conveys the label onwards flush against the gripping cylinder by way of the label side disposed opposite to the adhesive-coated side of the label. The gripping cylinder is set up in the region of a bottle table, which accommodates a multitude of bottles. When the bottle table is turned, the bottles are conveyed or conducted past the gripping cylinder, causing the bottles to roll against the adhesive-coated labels, whereby the labels are caused to adhere to the bottles.

Due to the diversity of interacting components of the machinery set, the above described labelling procedure is constructionally complicated and the process is difficult to control, in particular against the background of the desired high production output of about 60,000 labels per hour. The complexity of the process also results from the fact that in the subject labelling process, the adhesive must first be applied to the label.

In DE 35 04 164 A1 a process and an apparatus are described for applying labels onto containers or the like. The labels on their rear side carry over their entire surface an adhesive coating, which is activated by being dampened with water. The adhesive is of such composition that it permits a strong and durable adhesion of the labels against the plastic surface of bottles. On the other hand, the picking up of the labels individually or their removal from the stack of labels is accomplished with the use of conventional cold adhesive using its adhesive action, that is to say, in a manner which can only be practiced with uncoated labels, devoid of adhesive. By this expedient which, in part, results in a duplication of adhesive coating, it is intended to ensure that activatable labels as well can be processed with the same high throughput and accuracy as is the rule with non-coated labels. At the same time, the advantages of the activatable adhesive coating are to be preserved completely. The cold adhesive coating is adequate for a satisfactory initial adhesion between label and container, so that the activation of the adhesive coating can be performed at any optional point in time, prior to, during or after the application of the labels onto the containers. The apparatus being used therefor is designed in the afore described manner, that is to say, comprising the palette carrousel including the palettes, the gripping cylinder and the revolving bottle table with the multiplicity of bottles. By means of the palettes, the labels, in row regions on the remote side, are additionally supplied with two strips of cold adhesive. In the circumferential region of the bottle table, ahead of the gripping cylinder, a spray device is provided by which the region of the bottles, where the labels are to be applied, are wetted with water during their passage.

The described process and apparatus for performing the process according to that literature referenced above is cumbersome because of the duplicated adhesive application and the design of the apparatus required in this context.

From DE-OS 1 586 400 a labelling apparatus is known, for which it is proposed to employ labels which already carry an adhesive coating and to render this adhesive coating sticky by the application of water. It is proposed to design the feed system for the water pressure-less, the label which wipes past the apertures of an applicator head absorbing the necessary amount of water by the adhesive forces becoming effective.

A process and an apparatus for the application of labels to containers are also known from DE 41 05 524 C2.

### SUMMARY OF THE INVENTION

It is one object of the invention to propose a label with an adhesive coating, which is particularly sensitive to liquid, and which is suitable for employment in the high throughput range of labelling technology, as well as a preferred use of such a label, a process for the automatic application of a label as well as a process for the manufacture of a label paper.

One aspect of the invention proposes a label including a liquid-sensitive adhesive coating on its rear side, characterized in that the adhesive coating is based on natural biopolymers as well as their derivatives and/or synthetic polymers, which are activatable by liquid.

More particularly, a label paper may be used, which includes the liquid-sensitive adhesive coating. Conceivably, instead of paper, a porous foil, in particular a plastic foil can be provided with the liquid-sensitive adhesive coating. This porous foil may possess a certain vapor permeability, such that the moistened adhesive coating can dry after the label has been applied onto the container.

More particularly, caseins, proteins, alginates, gelatines, galactomananes, starch, chitin and their derivatives, vinyl alcohol (VAL), vinyl acetate (VAC), acrylic acid and their derivatives, and carboxymethylcellulose (CMC) are used for the adhesive coating.

The adhesive coating may comprise 60-100, preferably 70-95, in particular 80-95% of a starch derivative and 0-40, preferably 5-30, in particular 5-20% of a polymer based on a natural or synthetic substance, acting as a thickening agent.

The adhesive coating may have a solids content of 10-70, preferably 10-40, in particular 20-30%.

The viscosity of the adhesive coating may amount to 200-4000, preferably 400-3000, in particular 800-2500 mPas (Brookfield).

The adhesive coating is preferably activated with water or a water alcohol mixture. This liquid may additionally include a wetting agent and/or a thickening agent. The adhesive coating is not activated by atmospheric humidity.

Another aspect of the invention is a process according to the invention for the manufacture of the labels carrying a liquid-sensitive adhesive coating on the rear side thereof, which provides that the adhesive coating is applied to the label during the paper manufacture or paper beneficiation or in varnishing machines or in printing machines.

The label having a liquid-sensitive adhesive coating on its rear side is used, in particular, for labelling surfaces of glass, tinplate, aluminium, polyethylene terephthalate (PET), polyvinyl chloride (PVC), polyolefins (polyethylene (PE, polypropylene (PP)), polystyrene (PS) or composites comprising the aforegoing.

Accordingly, the invention proposes the replacement of the conventional wet adhesive labelling process by a system of an activating agent and a label specially treated on its rear side. The label develops its adhesive power by virtue of the activating agent. The adhesive bonding is not dissolved by condensation water or ice water. Once the adhesive coating has been activated, renewed moistening results in the formation of a sticky gel, and the adhesive does not dissolve, but the label can be pulled off mechanically. The adhesive coating may already be applied during the paper manufacture or beneficiation, in varnishing machines or printing machines. The adhesive coating is based on natural biopolymers as well as their derivatives and/or synthetic polymers, which can be activated with liquid and result in the aforementioned adhesive properties.

With this adhesive coating the activation agent attains an activation period of the adhesive force of greater than or equal to 40 ms. This ensures that containers can be fitted with labels under high throughput conditions.

Having regard to the afore described state of the art, the invention furthermore relates to a process for the automatic application of a label including a liquid-sensitive adhesive coating on its rear side onto a surface of a container, in particular onto a convexly curved surface of a bottle, wherein a multiplicity of stacked labels are provided with an adhesive coating in a label magazine. The containers are conveyed in relation to the label magazine, and means are provided for wetting the respective container or the label to be removed from the label magazine, this process being characterized in that the container and the label contained in the label magazine are directly brought into contact with one another and the container withdraws the label from the magazine.

With this process, it is not necessary to perform the process steps required by prior art applications, which use an adhesive roller, the palettes and the gripping cylinder. Instead, in the present invention, once the adhesive coating has been activated, the labels are applied directly onto the containers. In principle, it is thus only necessary that the containers are conveyed in relation to the label magazine. However, having regard to process reliability and constructional effort, it is considered advantageous that the label magazine is stationary and the containers, in particular bottles, are moved past the label magazine. The movement is performed in a particularly simple manner, as a rolling movement of the container against the rear side of the label. Accordingly, the container preferably takes the form of a cylindrical body, in particular a bottle, more particularly a beer bottle. This is revolved about its cylinder axis. The adhesive coating may be activated in a particularly simple manner in that the container is first sprayed with liquid, in particular in the region of the surface of the container receiving the label, whereafter this region of the container is brought into contact with the rear side of the label.

On the other hand, it is also possible to retrofit prior art labelling machines and methods to incorporate the features of the present invention. From that aspect, it is proposed that the label to be removed from the label magazine is withdrawn by a withdrawal member, the surface of which is wetted with liquid, the withdrawal member transferring the label adhering to the withdrawal member in the region of the adhesive layer to the labelling cylinder in such a manner that the side of the label opposite from the adhesive layer sits close against the labelling cylinder, and the labelling cylinder with the label is brought into contact with the container and fits the container with the label. The withdrawal member accordingly, in the context of the aforesaid description of the prior art, is represented by the palette, the labelling cylinder, and the gripping cylinder. Accordingly, in this mode of operation the liquid is not applied to the container or to the rear side of the label contained in the label magazine to be preferably brought into contact with a dry container, but instead, liquid is transferred onto the palette, instead of the adhesive roller, as it were, by way of a liquid application roller, the palette wetting the label and withdrawing it from the label magazine. From there the label with its adhesive coating already activated is fed to the gripping cylinder, and by means of the latter, is stuck onto the container, in particular the bottle. It is considered particularly advantageous that the region of the withdrawal member wetting the label takes the form of a sponge, a rubber or the like, or is provided with a surface structure. The liquid application roller is to be adapted to the requirements of the medium being the liquid instead of the medium being the adhesive when used as an adhesive roller.

These and other advantages of the invention will be further understood and appreciated by those skilled in the art by reference to the following written specification, claims and appended drawing.

### BRIEF DESCRIPTION OF THE DRAWING

In the following single FIGURE the design, in principle, of a labelling apparatus for the direct labelling under discussion is illustrated by way of example.

FIG. 1 is a partially schematic view of a labelling apparatus embodying the present invention.

### DETAILED DESCRIPTION OF THE PREFERRED EMBODIMENT

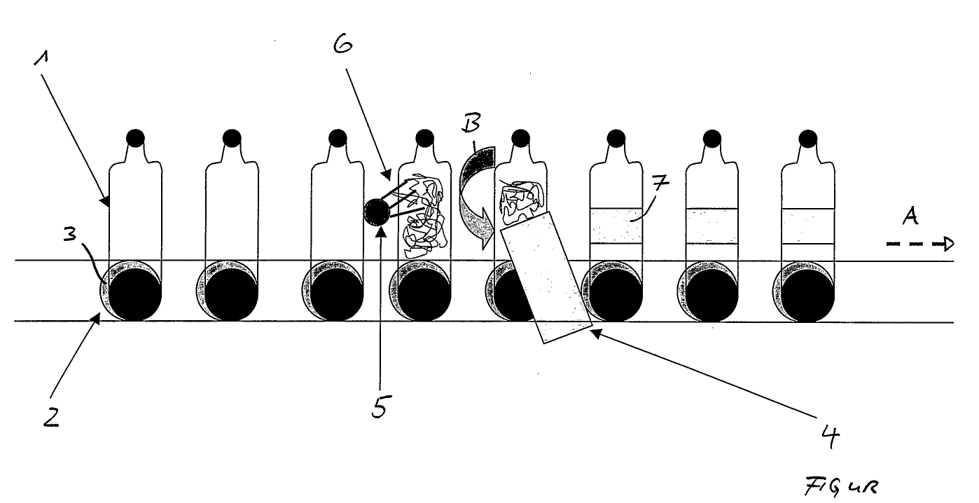

For purposes of description herein, the terms “upper”, “lower”, “right”, “left”, “rear”, “front”, “vertical”, “horizontal” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawing, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Bottles 1, in particular beer bottles, run on an endless belt 2 provided with revolving plates 3, past a label magazine 4. This label magazine 4 accommodates the multiplicity of labels, which on their rear side are provided with the liquid-sensitive adhesive coating. The conveyance direction of the endless belt is denoted by the arrow A, and the direction of rotation of the respective bottle 1 on the associated revolving plate 3 by the arrow B. Just prior to reaching the label magazine 4, the respective bottle 1 is sprayed with wetting liquid 6 in the region in which the label is to be positioned by means of a wetting device 5. The bottle 1 is turned when only in the region of the label magazine 4. By the rolling movement of the bottle 1 on the label next in line for being issued by the label magazine 4, the directly wetted bottle 1 directly picks up the specially treated label. It is apparent from the FIGURE that the bottles 1, which have passed the label magazine 4, are fitted with a label 7.

In the foregoing description, it will be readily appreciated by those skilled in the art that modifications may be made to the invention without departing from the concepts disclosed herein. Such modifications are to be considered as included in the following claims, unless these claims by their language expressly state otherwise.

1-9. (canceled)

10. A label for product containers and the like, comprising;
a liquid-sensitive adhesive coating disposed on a rear surface of said label, wherein said adhesive coating is based on natural biopolymers and/or derivatives thereof, which are activatable by a liquid, and includes chitin and/or derivatives thereof.

11. A label as set forth in claim 10, wherein:
said adhesive coating further including synthetic polymers, which are activatable by a liquid.

12. A label as set forth in claim 11, wherein:
said label is formed from a paper.

13. A label as set forth in claim 12, wherein:
said adhesive coating includes caseins, proteins, alginates, gelatins, galactomananes, starch, vinyl alcohol (VAL), vinyl acetate (VAC), acrylic acid and their derivatives, and carboxymethylcellulose (CMC).

14. A label as set forth in claim 13, wherein:
said adhesive coating comprises 60-100% of a starch derivative and 0-20% of a polymer based on a natural or synthetic substance, acting as a thickening agent.

15. A label as set forth in claim 14, wherein:
said adhesive coating has a solids content of 10 to 70%.

16. A label as set forth in claim 15, wherein:
said adhesive coating has a viscosity of 200-400 mPas (Brookfield).

17. A label as set forth in claim 16, wherein:
said adhesive coating is activatable by water or a water alcohol mixture, wherein the water or mixture is provided with a wetting agent and/or a thickening agent.

18. A label as set forth in claim 10, wherein:
said label is formed from a plastic porous foil.

19. A label as set forth in claim 18, wherein:
said foil includes said liquid-sensitive adhesive therein.

20. A label as set forth in claim 10, wherein:
said label is formed from a paper.

21. A label as set forth in claim 10, wherein:
said adhesive coating includes caseins, proteins, alginates, gelatins, galactomananes, starch, vinyl alcohol (VAL), vinyl acetate (VAC), acrylic acid and their derivatives, and carboxymethylcellulose (CMC).

22. A label as set forth in claim 10, wherein:
said adhesive coating comprises 60-100% of a starch derivative and 0-20% of a polymer based on a natural or synthetic substance, acting as a thickening agent.

23. A label as set forth in claim 10, wherein:
said adhesive coating has a solids content of 10 to 70%.

24. A label as set forth in claim 10, wherein:
said adhesive coating has a viscosity of 200-400 mPas (Brookfield).

25. A label as set forth in claim 10, wherein:
said adhesive coating is activatable by water or a water alcohol mixture, wherein the water or mixture is provided with a wetting agent and/or a thickening agent.

26. A method for labelling product containers and the like, comprising:
providing a plurality of discrete labels;
applying indicia to a front surface of each of the labels;
applying a liquid-sensitive adhesive coating to a rear surface of each of the labels, wherein the adhesive coating is based upon natural biopolymers and/or derivatives thereof, and includes chitin and/or its derivatives, thereby defining finished labels;
sequentially applying a liquid to the rear surfaces of the finished labels to activate the adhesive coating; and
sequentially pressing the rear surfaces of the adhesive activated finished labels against the containers to securely adhere the finished labels thereto.
